(19) United States
(12) Patent Application Publication
(10) Pub. No.: US 2011/0120299 A1
(43) Pub. Date: May 26, 2011

(54) CAST PISTON WITH PIN BORE LUBRICATION AND METHOD OF MANUFACTURING SAME

(75) Inventor: William R. Aro, Detroit, MI (US)

(73) Assignee: GM GLOBAL TECHNOLOGY OPERATIONS, INC., Detroit, MI (US)

(21) Appl. No.: 12/625,602

(22) Filed: Nov. 25, 2009

(51) Int. Cl. F01B 31/08; B23P 15/10

(52) U.S. Cl. 92/186; 29/888.04

(57) ABSTRACT

A piston has a one-piece, preferably cast aluminum, piston head with a cooling oil gallery completely surrounded by and within the head. The piston head has a pin bore for a piston pin that does not intersect with the cooling oil gallery. The pin bore is sized to maintain a substantially uniform clearance between the piston pin and the piston head. The piston head has a passage extending from the pin bore to the cooling oil gallery to allow cooling oil from the gallery to lubricate the piston pin. The passage is preferably drilled after the piston head is cast. Preferably, the pin bore does not have a recess at the passage. A method of manufacturing a piston includes casting the one-piece piston head and drilling a passage from the pin bore to the cooling oil gallery.

### TECHNICAL FIELD

The invention relates to a piston configured for lubrication of a piston pin bore, and a method of manufacturing the same.

### BACKGROUND OF THE INVENTION

Piston heads in internal combustion and diesel engines cycle up and down within engine cylinders, heating with both frictional heat and heat from combustion within the cylinder. Piston heads sometimes have an internal cooling gallery (i.e., a cavity in the head) to which cooling oil is fed to cool the piston head. The piston head connects to a cylinder rod via a piston pin nested in a piston pin bore in the cylinder head. The piston pin rotates partially within the pin bore as the rod moves up and down. The pin bore is sometimes plated to reduce frictional heat.

### SUMMARY OF THE INVENTION

A piston with a piston pin is provided with a one-piece piston head, preferably cast aluminum, having a cooling oil gallery completely surrounded by and within the head. The piston head has a pin bore for the piston pin that does not intersect with the cooling oil gallery. The pin bore is sized to maintain a substantially uniform clearance between the piston pin and the piston head. The piston head has a passage extending from the pin bore to the cooling oil gallery to allow cooling oil from the gallery to lubricate the piston pin. The passage is preferably drilled after the piston head is cast. The pin bore is substantially cylindrical and the passage opens at the substantially uniform clearance between the piston pin and the piston bore. Preferably, the pin bore does not have a recess at the passage. Thus, the cooling oil gallery, the passage and the clearance are sized to maintain cooling oil in the cooling oil passage and the passage when cooling oil flows through the passage to the clearance to lubricate the pin. Designs with a recess at the intersection of the pin bore and the passage may allow too much oil to drain from the passage, making it difficult to adequately lubricate the pin on engine startup. Furthermore, the drilled passage may enable the piston head to be completed with fewer processing steps compared to other piston head designs, as drilling a first passage from oil control rings on the circumference of the piston head, and then drilling another passage from the pin bore to intersect with the first passage is not required.

In one embodiment, the piston head has a boss partially defining the pin bore opposite the cooling oil gallery. The passage is drilled through the boss, so that the passage has a portion that extends through the boss and a portion that connects to the cooling oil gallery.

In another embodiment, the pin bore is a first pin bore and the passage is a first drilled passage. The piston head has a recessed opening and a second pin bore coaxial with the first pin bore and spaced apart from the first pin bore by the recessed opening. The piston head has a second drilled passage extending from the second pin bore to the cooling oil gallery to allow cooling oil from the gallery to lubricate the piston pin. The second pin bore is also characterized by the absence of any recess at the second drilled passage.

A method of manufacturing a piston head for a gasoline engine includes placing a salt core in a die cavity for a piston head. A one-piece piston head is cast with a piston pin bore by filling the die cavity with an aluminum alloy. The salt core is removed to establish a cooling oil gallery in the piston head. A passage is drilled from the piston pin bore to the cooling oil gallery so that oil from the cooling oil gallery will flow to the pin bore. The salt core allows the passage to be cast as one-piece, avoiding additional assembling and welding steps typically required with multi-piece steel piston heads.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a first embodiment of a piston head;

FIG. 2 is a schematic cross-sectional view of a second embodiment of a piston head;

FIG. 3 is a schematic cross-sectional view of a die assembly and salt core used in manufacturing the piston head of FIG. 1; and

FIG. 4 is a flowchart illustrating a method of manufacturing the piston heads of FIGS. 1 and 2.

### DESCRIPTION OF THE PREFERRED EMBODIMENTS

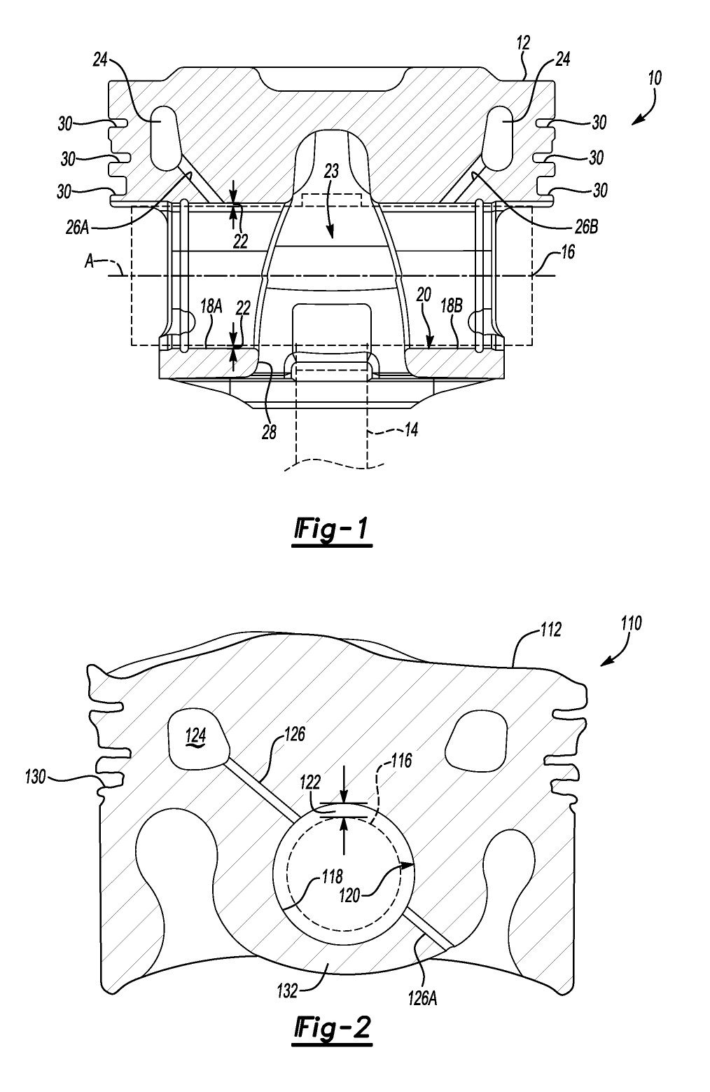

Referring to the drawings, wherein like reference numbers refer to like components throughout the several views, FIG. 1 shows a piston 10 including a one-piece piston head 12 connected for movement with a piston rod 14 by a piston pin 16. The piston rod 14 and piston pin 16 are shown in phantom for clarity of showing the piston head 12. The piston pin 16 is generally cylindrical with a center axis A. The piston rod 14 and piston pin 16 are connected by any known means.

The piston head 12 is one-piece cast aluminum alloy. Substantially cylindrical first and second piston pin bores 18A, 18B are cast into the head 12 and may be machined to a smooth interior surface 20. The piston bores 18A, 18B are axially aligned with one another about center axis A, which is the center axis of both the pin 16 and the bores 18A, 18B. The piston pin 16 and the pin bores 18A, 18B are sized to maintain a substantially uniform clearance 22 between the pin 16 and the surface 20 of the bores 18A, 18B. The piston bores 18A, 18B are spaced from one another by a recessed opening 23 cast into the head 12. The recessed opening 23 is the area where the rod 14 connects with the pin 16.

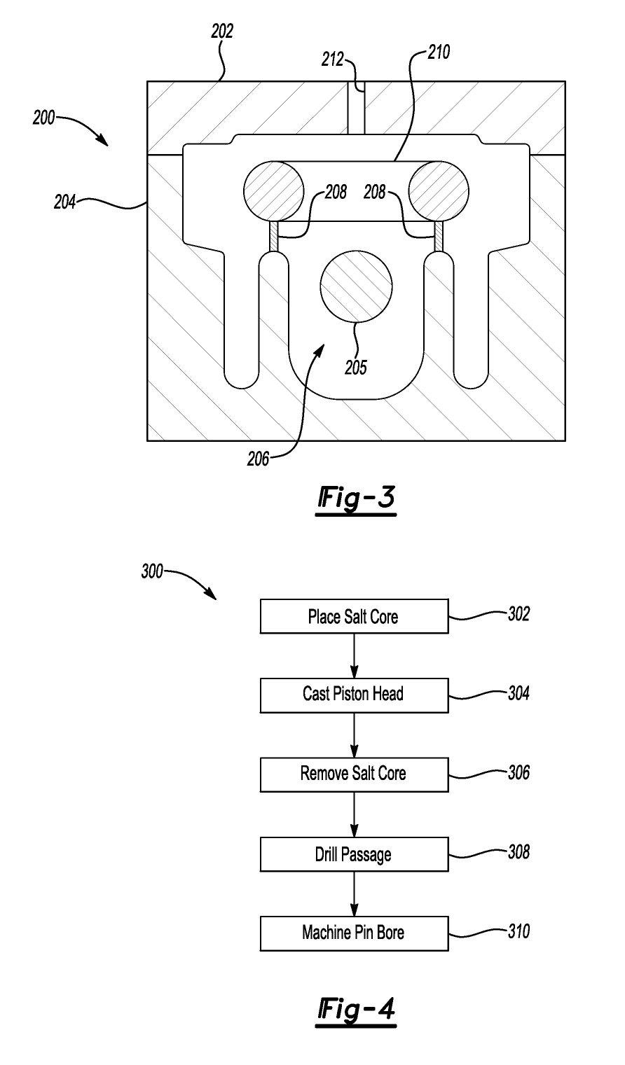

A generally annular cooling oil gallery 24 is encased within the head 12, lying above the bores 18A, 18B in the view of FIG. 1, and not intersecting with the bores 18A, 18B. The cooling oil gallery 20 has an inlet and an outlet, not shown in FIG. 1, but visible in FIG. 3, that are positioned to receive cooling oil sprayed from a nozzle within the recessed opening 23. Thus, cooling oil at least partially fills the cooling oil gallery 24, and flows therethrough to cool the surrounding cast aluminum. Preferably, the cooling oil gallery 24 is salt core formed according to the method of FIG. 4.

A first drilled passage 26A and a second drilled passage 26B are drilled from the respective pin bore 18A, 18B to the cooling oil gallery 24 by a drill accessing the drilling position through an open bottom portion 28 of the recessed opening 23, prior to insertion of the pin 16 and rod 14. The entrance of the drilled passages 26A, 26B at the pin bores 18A, 18B is at the generally cylindrical interior surface 20, at the same clearance 22 from the pin 16, without any added recess in the pin bores 18A, 18B at the passages 26A, 26B. The passages 26A, 26B and the clearance 22 are sized to ensure that some cooling oil remains in the passages 26A, 26B to be distributed around the clearance as the pin 16 moves so that the pin 16 is lubricated during operation and at engine startup, unlike designs with an added recess at the passages 26A, 26B that causes oil to immediately disperse from the passages 26A, 26B.

The design of the piston 10 is also superior to designs that provide cooling oil to the piston bores from the area of the sealing ring channels 30 on the outer surface of the head 12. Such designs require two drilled passages for each piston bore, a first drilled passage inward from the sealing ring channel 30 to just above the bore, between the cooling oil gallery and the bore, and then another drilled passage upward from the bore to intersect with the first passage. Not only do such designs have an extra processing step due to the two separate drilled passages that are required, but the cylinder head must be sufficiently thick between the cooling oil gallery and the bores to remain structurally sound to allow a passage to be drilled in that location. Thus, such designs require larger and heavier heads, reducing fuel economy and packaging space.

Additionally, the piston 10 is superior to piston designs that require a multi-piece head to form the cooling oil gallery, with a portion of the gallery formed by a first piece and a second piece welded to the first piece to enclose the gallery. The salt core formed cooling oil gallery 24 enables a precisely designed gallery shape in a one-piece head 12.

Referring to FIG. 2, another embodiment of a piston 110 with a one-piece cast aluminum alloy head 112 is shown. The piston head 112 has a cooling oil gallery 124 that is preferably salt core formed according to the method of FIG. 4. Furthermore, the piston head 112 has a piston pin bore 118 that is cast into the head 112. The piston pin bore 118 is generally cylindrical with a machined interior surface 120. A generally cylindrical piston pin 116 is placed in the bore and attached to a piston rod (not shown) for reciprocal movement in a cylinder of a gasoline engine. The piston pin 116 and bore 118 are configured to maintain a substantially uniform clearance 122. The head 112 has a boss 132 forming a lower portion of the pin bore 118. A passage 118 is drilled by positioning a drill below the boss 132 and drilling through to the cooling oil gallery 124. Thus, a portion 118A of the passage 118 is through the boss 132. By positioning the passage as shown, the drilling is made easier. A processing step is avoided as compared to designs that feed oil to the pin bore from the sealing ring channel 130, as these require two drilled passages, with a first drilled passage inward from sealing ring channel 130 to the cooling oil gallery and then another drilled passage upward from the pin bore to intersect with the first passage. Furthermore, the cylinder head 12 needn't be as thick in the location of the drilled passages of such designs. Additionally, the piston 110 is superior to piston designs that require a multi-piece head to form the cooling oil gallery, with a portion of the gallery formed by a first piece and a second piece welded to the first piece to enclose the gallery. The salt core formed cooling oil gallery 124 enables a precisely designed gallery shape in a one-piece head 112.

Referring to FIG. 3, a die assembly 200 is shown that may be used for casting the one-piece piston head 12 of FIG. 1. A substantially similar die assembly with differently shaped dies would be used in the same manner as described with respect to die assembly 200 and head 12 to cast the one-piece head 112. The die assembly 200 includes an upper die 202 and a lower die 204 that are configured to form a die cavity 206 when the dies 202, 204 are closed as shown. A portion 205 of the lower die 204 extends into and out of the plane of the drawing sheet and will form the pin bore 18A, 18B when the piston head 12 is cast. The dies 202, 204 may each have more than one piece that assemble together to form the shape needed to result in the cast piston head 12. Those skilled in the art will readily understand the various ways to design dies to provide the shape of the piston head 12.

Pins 208 are secured to the lower die 204. A salt core 210 is placed in the cavity 206 by positioning the salt core 210 on the pins 208 to be effectively suspended within the cavity 206. The dies 202, 204 are then closed, and aluminum alloy is poured through an inlet 212 to cast the one-piece piston head 12 of FIG. 1. The dies 202, 204 are then opened and the cast head 12 is removed from the dies 202, 204. The salt core 210 is then removed by spraying water through openings formed when the aluminum alloy is cast around the pins 208 and the head 12 is removed from the dies assembly 200, with the pins 208 remaining in the die assembly 200. The water acts to dissolve the salt core 210, leaving the oil cooling gallery 24 in its place.

Referring to FIG. 4, a method 300 is shown for manufacturing the one-piece piston head 12 of FIG. 1 using the die assembly 200 of FIG. 3. The method 300 applies equally to manufacturing the piston head 112. The method 300 begins with step 302, placing the salt core 210 in the die cavity 206. The method 300 then proceeds to step 304, casting the one-piece piston head 12 with the pin bores 18A, 18B. Next, in step 306, the salt core 210 is removed to establish the cooling oil gallery 24.

In step 308, passages 26A, 26B are drilled from the respective pin bores 18A, 18B to the cooling oil gallery 24. The drilling is done at a convenient angle from the bores 18A, 18B so that only one drilling step is required for each passage 26A, 26B. There are no recesses in the pin bores 18A, 18B where the drilled passages 26A, 26B intersect with the pin bores 18A, 18B. In step 310, the surface 20 of the pin bores 18A, 18B is machined so that a substantially uniform clearance 22 will be provided around the pin 16 in the bores 18A, 18B. The configuration of the passages 26A, 26B and the bores 18A, 18B with no recesses will ensure that some cooling oil remains in the passages 26A, 26B on engine start up for lubricating the pin 16.

While the best modes for carrying out the invention have been described in detail, those familiar with the art to which this invention relates will recognize various alternative designs and embodiments for practicing the invention within the scope of the appended claims.

1. A piston with a piston pin comprising:
a one-piece piston head having a cooling oil gallery completely surrounded by and within the head;
wherein the piston head has a pin bore for the piston pin that does not intersect with the cooling oil gallery; wherein the pin bore is sized to maintain a substantially uniform clearance between the piston pin and the piston head; and
wherein the piston head has a passage extending from the pin bore to the cooling oil gallery to allow cooling oil from the gallery to lubricate the piston pin.

2. The piston of claim 1, wherein the piston head has a boss partially defining the pin bore opposite the cooling oil gallery; and wherein a portion of the passage extends through the boss.

3. The piston of claim 1, wherein the pin bore is a first pin bore and the passage is a first drilled passage; wherein the piston head has a recessed opening and a second pin bore that is coaxial with the first pin bore and spaced apart from the first pin bore by the recessed opening; wherein the piston head has a second drilled passage extending from the second pin bore to the cooling oil gallery to allow cooling oil from the gallery to lubricate the piston pin.

4. The piston of claim 1, wherein the piston has a sealing channel circumscribing the one-piece head and not in fluid communication with the bore and the passage.

5. The piston of claim 1, wherein the piston head is cast aluminum and the cooling oil gallery is salt core formed.

6. A method of manufacturing a piston head for a gasoline engine, comprising:
placing a salt core in a die cavity for a piston head;
casting a one-piece piston head with a cast piston pin bore by filling the die cavity with an aluminum alloy;
removing the salt core to establish a cooling oil gallery in the piston head; and
drilling a passage from the piston pin bore to the cooling oil gallery.

7. The method of claim 6, further comprising:
machining the surface of the piston pin bore in the piston head to a substantially uniform diameter.

8. The method of claim 7, wherein the drilling is through a boss of the piston head around the piston pin bore and extends through the piston pin bore.

9. The method of claim 7, wherein the placing a salt core includes placing the salt core on pegs attached within the die cavity.

10. A method of manufacturing a piston head for a gasoline engine, comprising:
casting a one-piece piston head having first and second axially aligned cast piston pin bores spaced apart by a recessed opening therebetween; wherein the piston head has a salt core-formed cooling oil gallery that does not intersect with the piston pin bores; and
drilling a first passage and a second passage from the first piston pin bore and the second piston pin bore, respectively, to the cooling oil gallery by accessing the pin bores at the recessed opening; wherein the drilling is at substantially cylindrical portions of the bores so as to establish a substantially uniform clearance around a piston pin extending axially through the bores.
